(19) United States
(12) Patent Application Publication
(10) Pub. No.: US 2026/0057698 A1
(43) Pub. Date: Feb. 26, 2026

(54) INFORMATION PROCESSING APPARATUS, INFORMATION PROCESSING SYSTEM, INFORMATION PROCESSING METHOD, AND STORAGE MEDIUM

(71) Applicant: CANON KABUSHIKI KAISHA, Tokyo (JP)

(72) Inventor: Yuki KAMAMORI, Kanagawa (JP)

(21) Appl. No.: 19/274,969

(22) Filed: Jul. 21, 2025

(30) Foreign Application Priority Data
Aug. 20, 2024 (JP) 2024-139059

(51) Int. Cl. G06V 40/16; G06V 10/44; G06V 10/94; G06V 40/50

(52) U.S. Cl. CPC G06V 40/171; G06V 10/443; G06V 10/95; G06V 40/172; G06V 40/53

(57) ABSTRACT

An information processing apparatus of the present disclosure includes: a reception unit configured to receive a first image in which one or more persons are captured and designation of a specific region in the first image, from a user; and a registration unit configured to perform a registration process of registering feature information of a specific person included in the specific region among the one or more persons captured in the first image, and consent to registration of the feature information for the specific person is obtained from the user.

### BACKGROUND

### Field of the Technology

The present disclosure relates to a service in which feature information of a person captured in an image is registered.

### Description of the Related Art

A service that receives input of an image from a client service or an application and that recognizes whose face is captured in the inputted image (hereinafter, face recognition service) is widely used. A user of the service needs to perform in advance work of registering a face of a person to be a recognition target in the face recognition service.

Patent Literature 1 (Japanese Patent Laid-Open No. 2023-157932) discloses a procedure of registering a face image. In this procedure, explanation relating to handling of personal information in a system is first displayed on an initial screen in which a user performs an operation of registering a face image, and the user is requested to give consent to the handling of the personal information. Then, in the case where the consent of the user is obtained, the face image of the user himself/herself is captured with a camera provided in a registration device, is presented to the user, and is transmitted to a face management server with consent.

### SUMMARY

An information processing apparatus of the present disclosure includes: a reception unit configured to receive a first image in which one or more persons are captured and designation of a specific region in the first image, from a user; and a registration unit configured to perform a registration process of registering feature information of a specific person included in the specific region among the one or more persons captured in the first image, and consent to registration of the feature information for the specific person is obtained from the user.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a system configuration example of an information processing system;

FIG. 2A is a block diagram illustrating an example of a hardware configuration of an information processing apparatus, and FIG. 2B is a block diagram illustrating an example of a hardware configuration of a client terminal;

FIG. 3 is a diagram illustrating a functional configuration example of the information processing system in a first embodiment;

FIG. 4 is a flowchart illustrating a flow of a feature registration process in the first embodiment;

FIG. 5 is a diagram illustrating an example of face regions detected from an image;

FIGS. 6A to 6C are diagrams illustrating examples of UI screens;

FIG. 7 is a diagram illustrating an example of a feature information table in the first embodiment;

FIG. 8 is a diagram illustrating a functional configuration example of an information processing system in a second embodiment;

FIG. 9 is a flowchart illustrating a flow of a feature registration process in the second embodiment;

FIG. 10 is a diagram illustrating an example of a temporary storage table in the second embodiment;

FIG. 11 is a diagram illustrating a functional configuration example of an information processing system in a third embodiment;

FIG. 12 is a flowchart illustrating a flow of a feature registration process in the third embodiment; and

FIG. 13 is a diagram illustrating an example of a feature information table in the third embodiment.

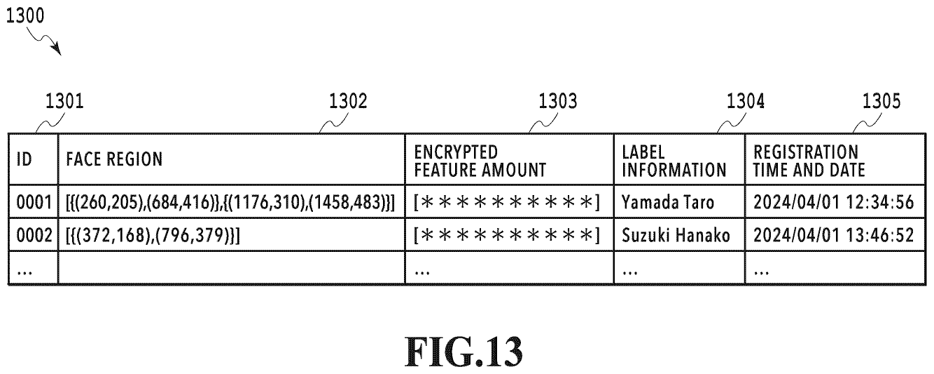

### DESCRIPTION OF THE EMBODIMENTS

A server of a face recognition service outputs a face recognition result based on a degree of similarity between a feature amount extracted from a face captured in an inputted image and a feature amount of a face of a person registered in advance. Accordingly, a user of the service needs to perform work of registering a face of a person to be a recognition target in the face recognition service in advance.

However, in the method described in Patent Literature 1, it is assumed that a captured image obtained by capturing a user himself/herself with a camera provided in a registration apparatus is set as a target of a registration process, and consent is obtained from the user himself/herself who is the subject of the captured image. Accordingly, the target of the process cannot be any image such as a snapshot in which multiple faces are captured. In recent years, a service that manages various images captured by a user in a cloud is also provided, and achieving both of various services and compliance with the AI ethics and the legal restraints described above has become a challenge.

In the present embodiment, explanation is given of an information processing system capable of providing a service complying with the AI ethics and the legal restraints in a service in which feature information of a person captured in an image is registered.

The present invention is explained below in detail based on preferrable embodiments of the present invention with reference to the attached drawings. Note that configurations illustrated in the following embodiments are merely examples, and the present invention is not limited to the illustrated configurations.

### First Embodiment

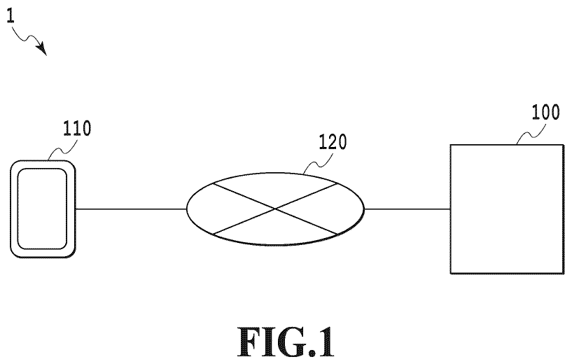

A system configuration of an information processing system according to the present embodiment is explained. FIG. 1 is a diagram illustrating an example of the system configuration of the information processing system 1 according to the present embodiment. As illustrated in FIG. 1, in the information processing system 1, an information processing apparatus 100 and a client terminal 110 are communicably connected to each other via a network 120 to form a server-client system. The information processing apparatus 100 functions as a server apparatus of the information processing system 1, and the client terminal 110 functions as a client.

Note that the information processing apparatus 100 that is the server may be implemented by one computer or may have a configuration including multiple computers. In the information processing system 1 illustrated in FIG. 1, a communication method used for connection between the apparatuses is, for example, communication standards of IEEE 802.11 series (Wi-Fi (registered trademark)) or Bluetooth (registered trademark). The communication between the apparatuses may be executed by Internet communication via a wireless LAN router, or the apparatuses may communicate with each other by mobile communication (3G, 4G, or 5G). The client terminal 110 is an information processing terminal used by the user, and has a web browser function for implementing browsing of a web site on the Internet and executing a web application provided by the server. The client terminal 110 is formed of, for example, a personal computer (PC), a smartphone, a tablet, or any other information processing terminal, or a camera or the like having a network communication function.

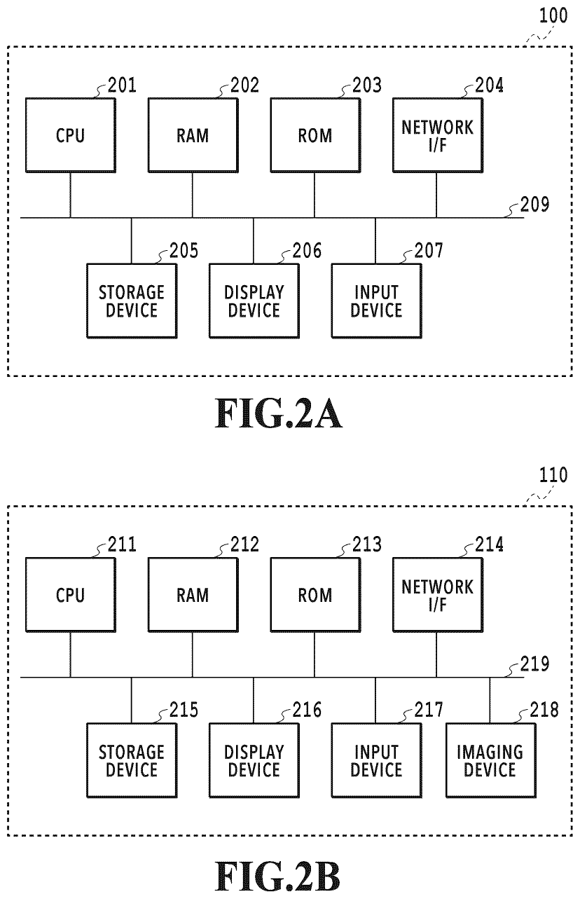

FIG. 2A is a diagram illustrating an example of a hardware configuration of the information processing apparatus 100. The information processing apparatus 100 is a computer, and includes a CPU 201, a RAM 202, a ROM 203, a network interface (I/F) 204, a storage device 205, a display device 206, and an input device 207. These units are connected to one another via a bus 209.

The CPU 201 performs operation control of the units forming the information processing apparatus 100, and is a subject that executes later-mentioned various processes performed by the information processing apparatus 100. The RAM 202 is a memory that temporarily stores data and control information, and is a work area used in the execution of the various processes by the CPU 201. Operation parameters, operation programs, and the like fixedly used by the information processing apparatus 100 are stored in the ROM 203.

The network I/F 204 provides a function of connecting to and communicating with the network 120. The information processing apparatus 100 exchanges data with an external apparatus via the network I/F 204. The storage device 205 is a device that stores data, and has an interface that receives I/O commands for reading and writing data. The storage device 205 may be a hard disk drive (HDD), a solid-state drive (SSD), an optical disc drive, a semiconductor storage device, or any other storage device. The storage device 205 stores computer programs and data that cause the CPU 201 to execute the later-mentioned processes executed by the information processing apparatus 100.

The display device 206 is, for example, a liquid crystal display (LCD), and displays information outputted from the CPU 201 in a state where the user can visually recognize the information. The input device 207 includes, for example, a keyboard, a mouse, a touch panel, and the like, receives input of information depending on an operation of the user, and inputs the information into the CPU 201.

FIG. 2B is a diagram illustrating an example of a hardware configuration of the client terminal 110. The client terminal 110 includes a CPU 211, a RAM 212, a ROM 213, a network I/F 214, a storage device 215, a display device 216, an input device 217, an imaging device 218, and the like. These units are connected to one another via a bus 219. Although a configuration of a smartphone having an imaging function is illustrated as the client terminal 110 in the example of FIG. 2B, the client terminal 110 is not limited to this configuration, and may have a different configuration. Since the CPU 211, the RAM 212, the ROM 213, the network I/F 214, the storage device 215, the display device 216, and the input device 217 are similar to the CPU 201, the RAM 202, the ROM 203, the network I/F 204, the storage device 205, the display device 206, and the input device 207 described above, explanation thereof is omitted. The imaging device 218 includes a lens and an imaging element such as charge coupled devices (CCD) or a complementary metal-oxide-semiconductor (CMOS), and inputs data of a captured image into the CPU 211.

In the present embodiment, the various functions provided by the information processing apparatus 100 are provided to the client terminal 110 as a web service. Specifically, the information processing apparatus 100 provides a user interface (UI) screen through a web browser of the client terminal 110. The information processing apparatus 100 executes processes corresponding to the various functions provided by the information processing apparatus 100 while displaying various pieces of data on the client terminal 110 through the UI screen and receiving input of data from the client terminal 110. Alternatively, a dedicated application may be installed in the client terminal 110. The client terminal 110 may execute this application to execute the processes corresponding to the various functions with the information processing apparatus 100 while exchanging data with the information processing apparatus 100. Moreover, the present disclosure is not limited to these forms, and the functions of the information processing apparatus 100 may be implemented by any method. Furthermore, various pieces of hardware forming the information processing apparatus 100 may be virtual hardware resources on a cloud. In this case, the information processing apparatus 100 transmits requests for executing the functions to the hardware resources via the network I/F 204, and obtains processing results via the network I/F 204.

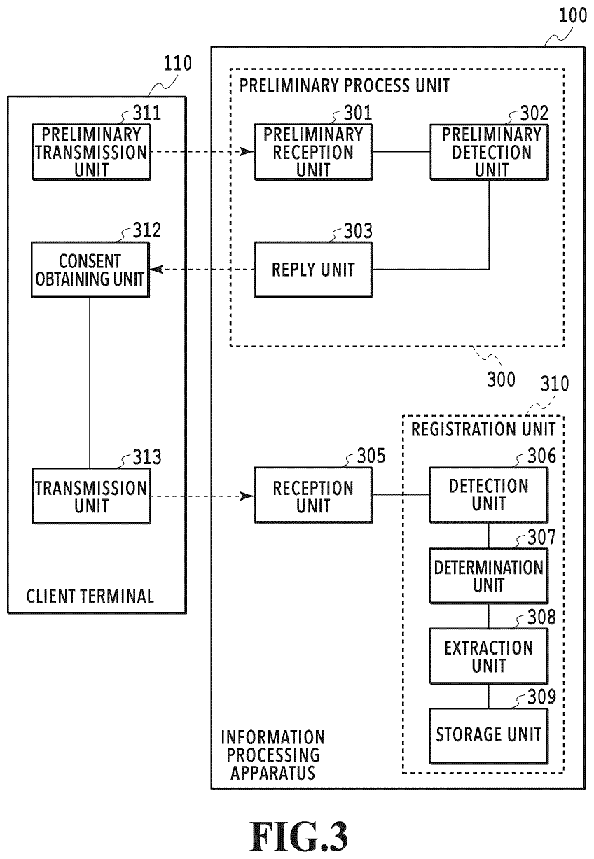

Next, a functional configuration of the information processing system 1 according to the present embodiment is explained. FIG. 3 is a diagram illustrating a functional configuration example of the information processing system 1 in the first embodiment. As illustrated in FIG. 3, the information processing apparatus 100 includes a preliminary process unit 300, a reception unit 305, and a registration unit 310. The preliminary process unit 300 includes a preliminary reception unit 301, a preliminary detection unit 302, and a reply unit 303. The registration unit 310 includes a detection unit 306, a determination unit 307, an extraction unit 308, and a storage unit 309. The client terminal 110 includes a preliminary transmission unit 311, a consent obtaining unit 312, and a transmission unit 313. The CPU implements functions of these functional units by invoking programs stored in the ROM or the storage device and executing processes according to the programs.

The reception unit 305 receives a first image in which a person is captured and designation of a specific region in the first image as an execution request of registration. The first image and the designation of the specific region in the first image are transmitted from the transmission unit 313 of the client terminal 110. The first image is data of an arbitrarily-captured image, and may be a still image or a moving image. Moreover, the first image may be an image captured by any imaging device. Furthermore, the first image is assumed to include one or multiple persons as a subject. The specific region is a region including a specific person who is the target of registration of the feature information. The designation of the specific region is expressed by information by which the position and the size of the specific region in the first image can be identified, and is expressed by, for example, coordinate values of two points in the first image. Specifically, in the case where the shape of the specific region is a rectangle on an image plane, the upper left coordinates and the lower right coordinates of this rectangular region can be used as the information relating to the designation of the specific region. Note that the information designating the specific region is not limited to this, and may be other information. For example, the information designating the specific region may be information indicating the upper left coordinates of the region, the size of the region, and the shape of the region.

In the first embodiment, the reception unit 305 receives the first image and the designation of the specific region in the first image after a preliminary process by the preliminary process unit 300. The preliminary process unit 300 receives a second image corresponding to the first image before the reception of the designation of the specific region by the reception unit 305. The preliminary process unit 300 detects one or multiple person regions from the second image, and sends the person regions to the client terminal as a reply. The specific region in the first image received by the reception unit 305 is designated from among the person regions sent by the preliminary process unit 300 as the reply. Each of the person regions is assumed to be detected as a region including a face. In the following explanation, the person regions are also referred to as face regions.

The preliminary reception unit 301 of the preliminary process unit 300 receives the second image from the preliminary transmission unit 311 of the client terminal 110. In the present embodiment, the second image is assumed to be an image identical to the first image. However, the second image does not have to be an image completely identical to the first image. For example, the first image and the second image may vary from each other by an image process or changes in some of color values in the images.

The preliminary detection unit 302 detects one or multiple person regions from the second image received by the preliminary reception unit 301. In the following explanation, one or multiple person regions detected from the second image are referred to as second person regions, and one or multiple person regions detected from the first image are referred to as first person regions. The reply unit 303 sends (transmits) information on the second person regions detected by the preliminary detection unit 302 to the client terminal 110. The information on the second person regions transmitted to the client terminal 110 includes at least information designating the position and the size of each person region in the second image. For example, in the case where each second person region is designated as the upper left coordinates and the lower right coordinates in the second image, a rectangular region whose diagonal line is a line connecting the upper left coordinates and the lower right coordinates is the second person region in the second image.

The client terminal 110 receives the information on the second person regions from the information processing apparatus 100 as the reply of the preliminary process. The consent obtaining unit 312 of the client terminal 110 presents the second person regions such that the user can visually recognize the second person regions. The client terminal 110 displays a screen depicting the second person regions obtained from the information processing apparatus 100, on the display device 216 of the client terminal 110. For example, the consent obtaining unit 312 cuts out regions corresponding to the second person regions from the second image transmitted by the preliminary transmission unit 311 to the information processing apparatus 100, and displays person images enlarged or shrunk to a predetermined size, on the screen. The screen is displayed on the display device 216 of the client terminal 110. Examples of the screen are described later.

The consent obtaining unit 312 inquires of the user about designation of one of the second person regions included in the reply of the preliminary process and consent to the registration of the feature information by the information processing apparatus 100 for the person included in the designated region. This inquiry is performed for each person. For example, on the screen described above, the inquiry about consent is performed for each of the persons displayed on the screen. Note that the designation of the second person region may be designation by a user operation or automatic designation by a process of the client terminal 110. For example, in the case where there is one second face region obtained as the reply of the preliminary process, the consent obtaining unit 312 may designate this one second person region, and inquire of the user about consent to the registration for a person in this region. Moreover, in the case where there are multiple second face regions obtained as the reply of the preliminary process, the consent obtaining unit 312 may designate and display the multiple second person regions one by one on the screen, and inquire of the user about consent to the registration for the person in the designated region together with the display of the designated region. In the following explanation, an example in which the region is designated by the user operation is explained.

In the case where the consent obtaining unit 312 obtains the consent of the user for the person included in the designated region, the transmission unit 313 of the client terminal 110 sets this region as the specific region, and transmits designation information of the specific region to the information processing apparatus 100 together with the first image. As described above, the first image is normally the same image as the second image. Note that the transmission unit 313 may also transmit information indicating that the consent for the specific person included in the specific region is obtained, together with the designation information of the specific region and the first image, to the information processing apparatus 100.

Note that the user who answers the inquiry about the consent does not have to be the person captured in the region. The user who answers the inquiry about the consent is a user of the face registration service, and is assumed to be a person who captures the first image (second image), a person who owns the first image (second image), an assistant who assists the registration, or the like, in addition to the person captured in the region. Specifically, the user who responds to the inquiry about the consent is a person such as a family member or a friend of the person captured in the region or a person who receives a permission from the person captured in the region. Note that, in the case where no consent of the user is obtained, the transmission unit 313 of the client terminal 110 does not transmit the first image and the designation of the specific region.

The registration unit 310 of the information processing apparatus 100 registers the feature information of the specific person included in a region matching the designated specific region, the region being one of the first person regions that are the one or multiple person regions included in the first image received by the reception unit 305. Note that “match” in the present specification means that the positions, the sizes, and the shapes of compared regions are identical or similar to one another. Similar means that a value of overlapping degree to be described later is equal to or more than a predetermined value.

The registration unit 310 first detects one or multiple person regions (first person regions) included in the first image with the detection unit 306. For example, the registration unit 310 detects regions including faces of persons. Next, the determination unit 307 determines whether the first person regions detected by the detection unit 306 include a region matching the region (specific region) corresponding to the designation received by the reception unit 305. In the case where there is a matching region, this matching region is identified as the specific region. The extraction unit 308 extracts a feature amount of a person, in this case a feature amount of a face for the specific region. The determination of matching is performed based on, for example, an overlapping degree of the regions. The overlapping degree is described later. The storage unit 309 stores the feature amount of the face extracted from the specific region in the storage device 205 as the feature information of the specific person.

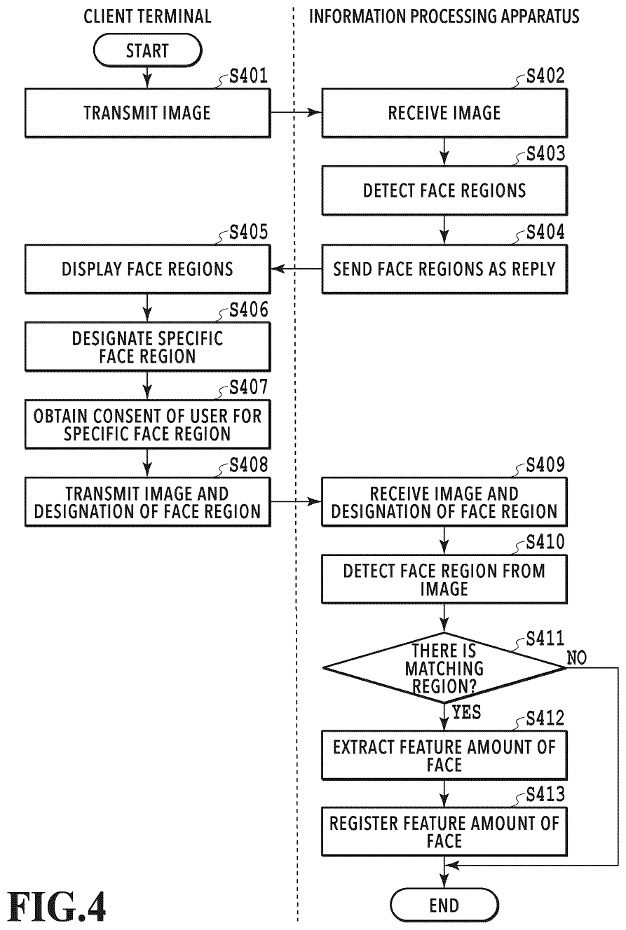

Next, explanation is given of a feature registration process executed by the information processing system 1 in the first embodiment. FIG. 4 is a flowchart illustrating a flow of the feature registration process in the first embodiment, and registration of a feature amount of a face of a person is explained as an example. Processes illustrated in S402 to S404 and S409 to S413 of the present flowchart are described in a program of a web application stored in the ROM 203 or the storage device 205 of the information processing apparatus 100. The program is invoked by the CPU 201, is expanded on the RAM 202, and is executed by the CPU 201. Moreover, processes illustrated in S401 and S405 to S408 of the present flowchart are described in a program of a web application expanded on the RAM 212 of the client terminal 110, and is executed by the CPU 211 of the client terminal 110.

The client terminal 110 accesses a web site provided by the information processing apparatus 100 through the web browser. In the case where a login process is completed, the information processing apparatus 100 transmits a top screen including a menu list to the client terminal 110. In the case where a face registration menu in the top screen is selected from the client terminal 110, the CPU 201 of the information processing apparatus 100 starts the process of the present flowchart. Sign “S” in the following explanation means step. In the feature registration process of FIG. 4, S401 to S404 among the processes executed by the information processing apparatus 100 are referred to as preliminary process, and S409 to S413 are referred to as registration process.

In S401, the CPU 211 of the client terminal 110 transmits an image to the information processing apparatus 100 as an execution request of the preliminary process of the face registration. The image transmitted in this case is the second image described above. The second image is an image stored in the storage device 215 of the client terminal 110 or an image captured with the imaging device 218 of the client terminal 110. The second image may be a still image or a moving image. The user selects the second image, and transmits the second image to the information processing apparatus 100. Note that the information processing apparatus 100 may display a dialog screen for selecting the second image on the client terminal in the case where the face registration menu is selected.

In S402, the CPU 201 of the information processing apparatus 100 receives the second image transmitted from the client terminal 110, as the execution request of the preliminary process of the face registration.

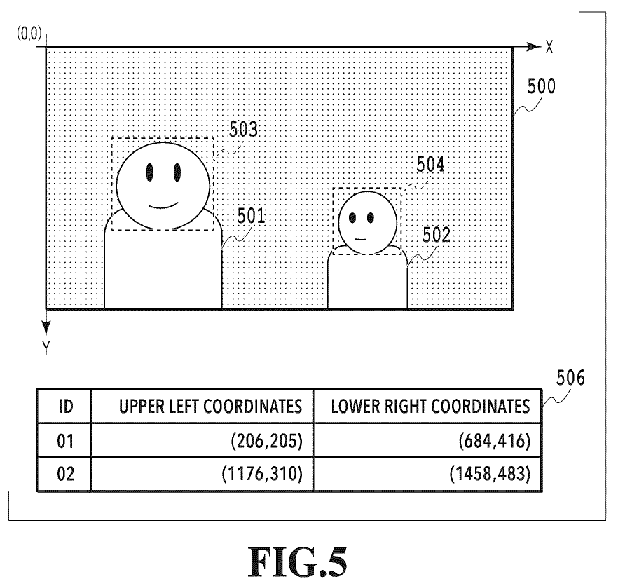

In S403, the CPU 201 detects regions of faces of persons from the image received in S402. FIG. 5 is a diagram illustrating an example of face regions detected from the second image. Two persons 501 and 502 are captured in a second image 500, and face regions 503 and 504 are detected for these persons 501 and 502, respectively. The CPU 201 obtains coordinate information 506 of the face regions 503 and 504 in an image coordinate system of the second image 500. The image coordinate system is a two-dimensional coordinate system including coordinate axes in two directions orthogonal to each other. In the example of FIG. 5, an upper left point of the image is the origin (0, 0), a horizontal direction in FIG. 5 is an X axis, and a vertical direction in FIG. 5 is a Y axis. For example, the position and the size of each of the face regions 503 and 504 are identified as a rectangular region identified by the upper left coordinates and the lower right coordinates of the region. In the example of the coordinate information 506, the face region 503 with the upper left coordinates (206, 205) and the lower right coordinates (684, 416) is detected as region ID “01”. Moreover, the face region 504 with the upper left coordinates (1176, 310) and the lower right coordinates (1458, 483) is detected as region ID “02”.

In the present embodiment, the CPU 201 detects regions estimated to be faces from an inputted image (second image) by using a publicly-known technique such as an inference machine trained by deep learning, and outputs image information of the detected face regions. Moreover, in the case where the inputted image is a moving image, the CPU only needs to detect regions estimated to be faces by using the inference machine as in the case of the still image for one representative frame in the moving image. Note that the detection method of the face regions is not limited to the method using deep learning, and any other method may be used.

In S404, the CPU 201 of the information processing apparatus 100 sends the information on the face regions detected in S403 to the client terminal 110 as a reply. Specifically, the CPU 201 transmits the coordinate information 506 of FIG. 5 to the client terminal 110. In this stage, the second image is not held in the information processing apparatus 100. This is to reduce data holding cost and comply with legal restraints.

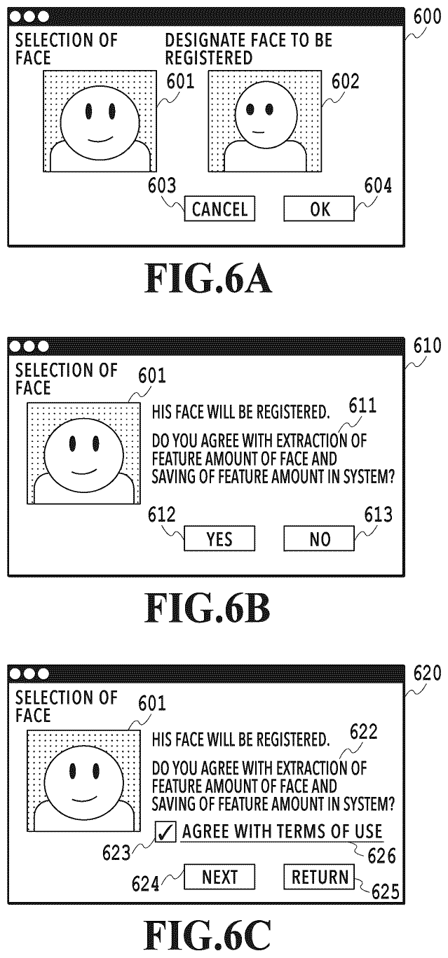

In S405, the CPU 211 of the client terminal 110 displays face images corresponding to the face regions 503 and 504 received as the reply from the information processing apparatus 100, on the display device 216 of the client terminal 110. FIGS. 6A to 6C are diagrams illustrating examples of screens displayed in the client terminal 110. First, in S405, the CPU 211 of the client terminal 110 displays a face selection screen 600 illustrated in FIG. 6A, on the display device 216. In FIG. 6A, face images 601 and 602 corresponding to the face regions 503 and 504 detected in the preliminary detection process of S403 are displayed side by side. The CPU 211 cuts out the face regions from the second image transmitted in the preliminary process based on the coordinate information of the face regions 503 and 504 received as the reply from the information processing apparatus 100, and displays the face regions on the screen. Note that the face images 601 and 602 do not have to be displayed in a state where the sizes thereof are the same as the sizes of the second face regions in the second image. On the face selection screen 600, the face images 601 and 602 may be displayed while being enlarged or shrunk to an appropriate size such that the user can visually recognize each face. Moreover, although the example in which the face images obtained by cutting out the face regions from the second image are displayed is illustrated in the example of FIG. 6A, the present disclosure is not limited to this. The configuration may be such that a frame line of an appropriate size is displayed at an appropriate position on the second image to indicate each of the face regions included in the reply.

In the case where one of the images of the face regions is designated by a user operation and an OK button 604 is operated in S406, the CPU 211 causes the process to proceed to S407, and the screen transitions to a consent screen 610 of FIG. 6B. In the case where a cancel button 603 is operated, the present flowchart is terminated, or the process returns to the face region detection (S403).

In S407, the CPU 211 displays the consent screen 610 of FIG. 6B on the display device 216. Then, the CPU 211 obtains the consent of the user for the face included in the specific face region designated by the user in S405. In the consent screen 610 of FIG. 6B, the face image 601 designated in FIG. 6A and a message 611 requesting for consent are displayed. Contents of the message 611 are, for example, “This face will be registered. Do you agree with extraction of feature amount of face and saving of feature amount in system?” or the like. As illustrated as an example, the message 611 includes a text requesting consent to extraction and registration of the feature amount of the face by the information processing apparatus 100. Moreover, the consent screen 610 is provided with a “yes” button 612 pressed in the case where the user gives the consent and a “no” button 613 pressed in the case where the user does not give the consent. In the case where the user operates the “yes” button 612, the CPU 211 causes the process to proceed to S407, and the screen transitions to a confirmation screen 620 in FIG. 6C. In the case where the user operates the “no” button 613, the present flowchart is terminated, or the process returns to the face region detection (S403).

A link 626 to terms of use and a check box 623 are displayed on the confirmation screen 620 of FIG. 6C, in addition to the information displayed on the consent screen 610 illustrated in FIG. 6B. Moreover, the confirmation screen 620 is provided with a “next” button 624 and a “return” button 625. In the case where the user operates the link 626 to terms of use, the screen transitions to a page of terms of use relating to the face recognition service. In the case where the check box 623 is pressed once, a check mark is displayed. In the case where the check box 623 is pressed again, the displayed check mark disappears. In S407, in the case where the user operates the “next” button 624 in a state where the check mark is displayed in the check box 623, the CPU 211 assumes that the consent is obtained, and saves the coordinate information of the face region corresponding to the designated face image 601, in the RAM 212. Then, the CPU 211 closes the confirmation screen 620 of FIG. 6C, and the process proceeds to S408. In the case where the user operates the “return” button 625, the screen returns to the face selection screen 600 illustrated in FIG. 6A.

Note that, in the example of FIG. 6A, description is given of the example as follows: the face images 601 and 602 corresponding to the multiple face regions detected from the second image are displayed side by side; the user selects one of the images of the face regions; and the screen transitions to the subsequent consent screen 610. However, the screen configuration may be a different screen configuration. The consent screens 610 on which the face images corresponding to the multiple detected face regions are displayed, respectively, may be sequentially displayed. For example, in the case where the two face regions 503 and 504 are detected as illustrated in FIG. 5, first, an inquiry about the consent for the face image 601 corresponding to one face region 503 is made on the consent screen 610 of FIG. 6B. In the case where the user operates the “yes” button 612, the screen transitions to the confirmation screen 620 of FIG. 6C. In the case where the user operates the “no” button 613, the confirmation screen 620 of FIG. 6C is skipped, and the consent screen 610 displaying the face image 602 corresponding to the next face region 504 is displayed.

In the case where the user operates the “next” button 624 in the state where the checkmark is inputted in the check box 623 in the confirmation screen 620, the CPU 211 assumes that the consent is obtained, and stores the coordinate information of the face region corresponding to the face image, in the RAM 212. Then, the consent screen 610 displaying the face image 602 corresponding to the next face region 504 is displayed. In the case where the user operates the “next” button 624 in a state where no checkmark is inputted in the check box 623 in the confirmation screen 620, the CPU 211 assumes that the consent is not obtained, and displays the consent screen 610 displaying the face image 602 corresponding to the next face region 504. In the case where the inquiry about consent for all face regions included in the reply is performed and answers to the inquiry are obtained, the process proceeds to S408.

Note that the display form of each of the screens 600, 610, and 620 may be any display form as long as the face images being the targets of consent are displayed such that the user can visually recognize the face images. For example, frames illustrating the detected face regions may be displayed on the second image. Moreover, selection of the face to be the target of consent may be received from the face regions by selecting any of these frames. Furthermore, the configuration may be such that, on the face selection screen 600, checkmarks are displayed for the faces to be the targets of consent in response to designation operations by the user, and consent is performed in a batch for the faces for which the checkmarks are displayed. Moreover, confirmation items necessary for the consent other than the terms of use may be added to the screen.

In the case where the consent is obtained for none of the face regions in S407, the CPU 211 does not execute the processes of S408 and beyond, and terminates the present flowchart. In the case where the consent is obtained for at least one of the face regions in S407, the process proceeds to S408.

In S408, the CPU 211 of the client terminal 110 transmits the first image and the designation information of the face region for which the consent is obtained from the user, to the information processing apparatus 100 as an execution request of the face registration. The first image transmitted in this case is assumed to the same image as the second image preliminarily transmitted in S401. The designation information of the face region is the coordinate information of the face region saved in the RAM 212 as the coordinate information for which the consent is obtained.

In S409, the CPU 201 of the information processing apparatus 100 receives the first image and the designation information of the face region for which the consent is obtained from the user, that is the specific region, as the execution request of the face registration.

In S410, the CPU 201 of the information processing apparatus 100 detects one or multiple face regions from the first image received in S409. The one or multiple face regions detected from the first image by the information processing apparatus 100 after the reception of the first image and the specific region are also referred to as first face regions.

In S411, the CPU 201 of the information processing apparatus 100 determines whether or not the first face regions detected in S410 include a region matching the region relating to the designation received in S409. In the determination process, the CPU 201 calculates the overlapping degree between the region relating to the designation received in S409 and each of the first face regions detected by the CPU 201 in S410. The CPU 201 determines whether the regions match or not based on a value of the overlapping degree. The overlapping degree is an index expressing a ratio of overlapping of images, and for example, an evaluation index referred to as intersection over union (IoU) can be used. The larger the IoU is, the more the images overlap each other. The CPU 201 assumes that the first face region whose value of the overlapping degree is the largest and is larger than a predetermined threshold is the region “matching” the region relating to the designation. The first face region whose value of the overlapping degree is not the largest or is not larger than the predetermined threshold is assumed to be a region “not matching” the region relating to the designation.

A method of calculating the overlapping degree is explained. The CPU 201 calculates the overlapping degree as a ratio of an “AND region of the target face region that is one of the detected first face regions and the region relating to the designation received from the client terminal 110” to an “OR region of the target face region and the region relating to the designation”. The CPU 201 calculates the overlapping degree while setting each of the first face regions detected from the first image as the target. Then, the first face region whose value of the overlapping degree is the largest and is larger than the predetermined threshold is set as the specific region as described above. The overlapping degree is expressed by the following formula 1.

$$Overlapping degree = ( AND region of target face region and region relating to designation ) / ( OR region of target face region and region relating to designation ) \qquad ( 1 )$$

Moreover, in the case where there are multiple target face regions whose overlapping degrees are the largest, the target face region whose likelihood is the largest is preferentially assumed to be the “matching” region (specific region). The likelihood is a score calculated in the course of the face region detection process in S410. The higher the value of the likelihood is, the higher the trustworthiness of the target face region being a face, in other words, the higher the likelihood of the detected region being a “face”. In the case where there are multiple face regions with the same overlapping degree for the positions, the sizes, and the shapes of the face regions, the region that is most trustworthy as being a face is prioritized based on the likelihood.

In the case where the CPU 211 determines that the detected first face regions does not include the region matching the region relating to the designation in S411 (S411; NO), the present flowchart is terminated, and the feature registration process is terminated. Meanwhile, in the case where CPU 211 determines that the detected first face regions include the region matching the region relating to the designation in S411 (S411; YES), the process proceeds to S412.

In S412, the CPU 201 extracts the feature amount of the face while setting the region (specific region) matching the region relating to the designation in the first image as the target. In the present embodiment, the CPU 201 extracts the feature amount of the face as an N-dimensional vector by using an inference model trained in advance by using a publicly-known technique such as deep learning. Note that the extraction process of the feature amount of the face is not limited to this method, and any method may be used as long as the extraction of the feature amount is possible.

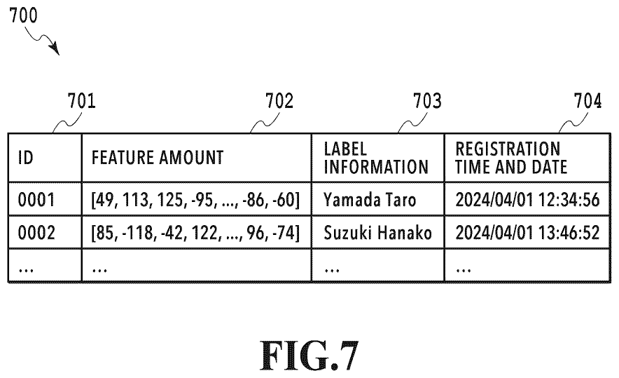

In S413, the CPU 201 stores the feature amount of the face extracted in S412 in the storage device 205 as the feature information. FIG. 7 is a diagram illustrating an example of a feature amount table 700 stored in the storage device 205. As illustrated in FIG. 7, records including an ID column 701, a feature amount column 702, a label information column 703, and a registration time and date column 704 are accumulated and stored in the feature amount table 700. IDs for uniquely identifying the registered faces are stored in the ID column 701. The feature amounts of the faces corresponding to the face regions identified with the ID column 701 are stored in the feature amount column 702. Additional information for identifying the face regions is stored in the label information column 703. For example, names of persons are stored. Times and dates at which the feature amounts of the faces are registered are stored in the registration time and date column 704. Note that the information stored in the feature amount table 700 is an example, and is not limited to this.

As explained above, in the case where an image is transmitted from the client terminal 110, the information processing apparatus 100 of the first embodiment presents face regions detected from the transmitted image on the client terminal 110 as the reply to the transmission such that the user can visually recognize the face regions. In the client terminal 110, the consent to the registration of the face feature amount in the face recognition service is obtained from the user individually for each of the presented face regions. The client terminal 110 transmits the designation of the face region and the image to the information processing apparatus 100 for the face region for which the consent is obtained from the user. The information processing apparatus 100 detects face regions from the received image, identifies a region matching the region relating to the designation among the detected face regions, and extracts and registers the feature information of the face. The information processing apparatus 100 can thereby set any image as a target and register the feature information of a specific person captured in the image. Moreover, even in the case where the image includes multiple faces, the feature information of the face can be registered for a specific face for which the user has given consent. Accordingly, it is possible to provide a service complying with AI ethics and legal restraints in a service in which the feature information of a person captured in an image is registered.

Executing the feature registration process in the above-mentioned procedure allows the feature amount of the face that is personal information to be safely registered also in the case where data is exchanged via a network. Specifically, since the feature information of the face is not directly exchanged between the client terminal 110 and the information processing apparatus 100, leak of the feature information does not occur during the exchange of data. Moreover, since the information processing apparatus 100 does not have to save the face image, it is possible to reduce data holding cost, and comply with legal restraints. Furthermore, there is a time lag between the reception of the image in the preliminary process and the reception of the image in the registration process. If the image is altered or changed to a different image in this time lag, determination of no match is likely to be given in the determination of the matching of the regions, and continuance of the process is inhibited.

Note that, although the method of detecting the regions estimated to be the faces by using a publicly-known technique such as the inference machine trained by deep learning is explained as the detection process of the face regions in the first embodiment, the present disclosure is not limited to this method. For example, the detection of the face regions may be implemented by an algorithm of a form other than the form of the inference model. Moreover, although the method of extracting the feature amount of the face as the N-dimensional vector by using the inference model trained in advance by a publicly-known technique such as deep learning is explained as the extraction method of the feature amount of the face in the above-mentioned embodiment, the present disclosure is not limited to this method. For example, the extraction of the feature amount of the face may be implemented by an algorithm of a form other than the form of the inference model. Alternatively, the feature amount of the face may be extracted as information that is not a vector. Moreover, although the method in which the overlapping degree is calculated as the ratio of the “AND region of the target face region and the region relating to the designation” to the “OR region of the target face region and the region relating to the designation” is explained in the present embodiment, the present disclosure is not limited to this calculation method. For example, the area of the “AND region of the target face region and the region relating to the designation” may be calculated as the overlapping degree. Moreover, a value of the “AND region of the target face region and the region relating to the designation” with respect to the “target face region” may be calculated as the overlapping degree. In addition, the configurations of the screens and the procedure of the processes in the flowchart are examples, and the present disclosure is not limited to the above-mentioned examples.

### Second Embodiment

In the first embodiment, description is given of an example of the procedure in which the detection of the person regions is executed twice in the series of processes of feature registration from the preliminary process to the registration process. In a second embodiment, explanation is given of a processing procedure in which the detection of the person regions is performed once. Note that, also in the second embodiment, as in the first embodiment, the information processing apparatus 100 presents the faces of the registration targets to the user to obtain the consent individually for each face, and then registers the feature information of the face in the face recognition service. Note that, since a system configuration and a hardware configuration of the information processing system in the second embodiment are similar to those in the first embodiment, explanation thereof is omitted, and the second embodiment is explained with the same units denoted by the same reference numerals. Moreover, points different from the first embodiment are mainly explained.

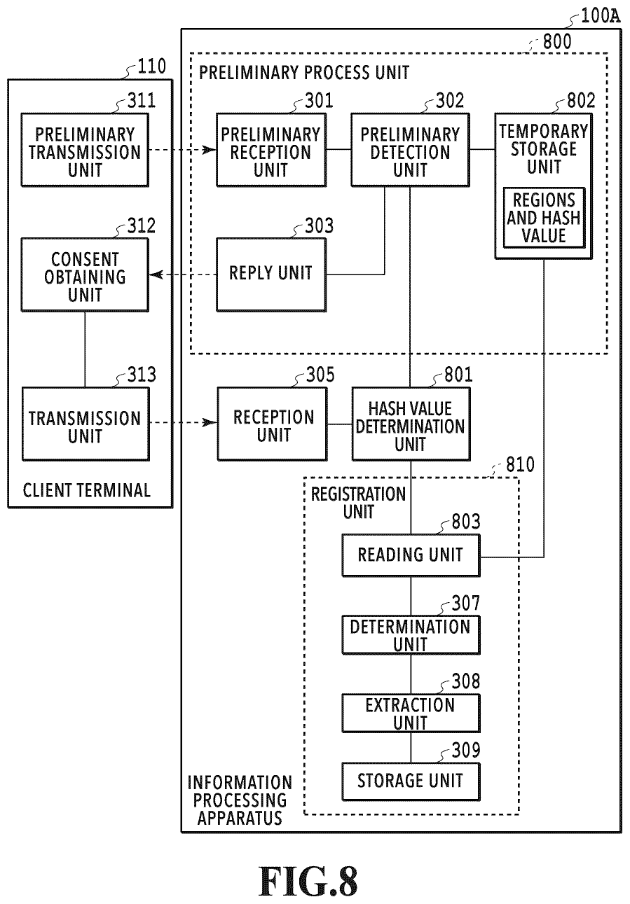

A functional configuration of the information processing apparatus 100A according to the second embodiment is explained. FIG. 8 is a block diagram illustrating the functional configuration of the information processing apparatus 100A according to the second embodiment. Note that units in FIG. 8 that are identical to the units in the functional configuration of the first embodiment are denoted by reference numerals identical to those in the first embodiment. The CPU implements functions of the functional units described below by invoking a program stored in the ROM or the storage device and executing processes according to the program.

The information processing apparatus 100A of the second embodiment includes a preliminary process unit 800, a hash value determination unit 801, the reception unit 305, and a registration unit 810. The client terminal 110 includes the preliminary transmission unit 311, the consent obtaining unit 312, and the transmission unit 313 as in the first embodiment.

The preliminary process unit 800 includes the preliminary reception unit 301, the preliminary detection unit 302, a temporary storage unit 802, and the reply unit 303. The registration unit 810 includes a reading unit 803, the determination unit 307, the extraction unit 308, and the storage unit 309. The hash value determination unit 801 is used by both of the preliminary process unit 800 and the registration unit 810.

The hash value determination unit 801 calculates hash values of images. The hash value determination unit 801 calculates the hash value for the image (second image) received by the preliminary reception unit 301. Moreover, the hash value determination unit 801 calculates the hash value for the image (first image) received by the reception unit 305. The hash value determination unit 801 calculates the hash values of the images by using the same algorithm for the case where the hash value determination unit 801 is executed in the preliminary process unit 800 and for the case where the hash value determination unit 801 is executed in the registration unit 810. In the present embodiment, for example, the hash values are assumed to be calculated by calculation using SHA-256 algorithm. However, the present disclosure is not limited to this, and any other algorithm can be used. If the first image and the second image are the same image, the same hash value is obtained. If not, different hash values are obtained.

The temporary storage unit 802 stores the hash value calculated for the second image in the preliminary process unit 800 and one or multiple person regions detected from the second image by the preliminary detection unit 302 in association with each other. In the following description, the person regions detected from the second images are assumed to be regions of faces of persons. The one or multiple face regions detected from the second image are referred to as second face regions.

The reply unit 303 transmits information on the second face regions detected from the second image by the preliminary detection unit 302, to the client terminal 110.

In the registration unit 810, the hash value determination unit 801 calculates the hash value for the image (first image) received by the reception unit 305, and passes the hash value to the reading unit 803. The reading unit 803 makes a query about (reads) the second face regions from the temporary storage unit 802 by using the hash value calculated for the image received by the reception unit 305. The determination unit 307 determines whether or not the second face regions read by the reading unit 803 includes a region matching the region relating to the designation received by the reception unit 305. The determination of matching is the same as that in the first embodiment. In the case where there is a matching region, the extraction unit 308 extracts a feature amount of a face for this specific region. The storage unit 309 stores the feature amount of the face extracted from the specific region in the storage device 205.

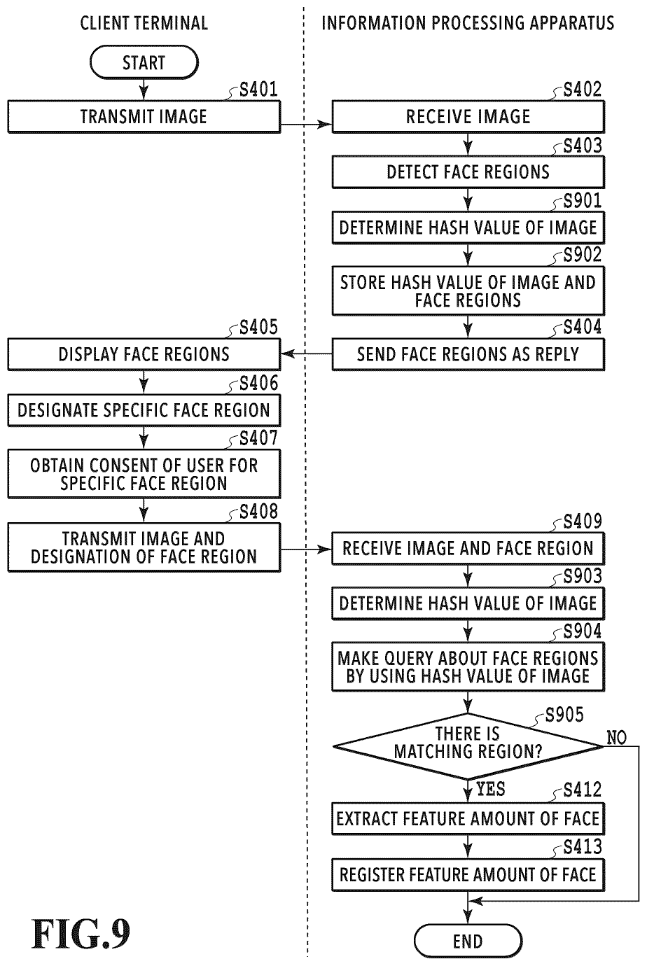

Next, a feature registration process executed by the information processing system 1A in the second embodiment is explained. FIG. 9 is a flowchart illustrating a flow of the feature registration process in the second embodiment. Processes illustrated in S402, S403, S901, S902, S404, S409, S903 to S905, S412, and S413 of the present flowchart are described in a program of a web application stored in the ROM 203 or the storage device 205 of the information processing apparatus 100A. The program is invoked by the CPU 201, expanded on the RAM 202, and executed by the CPU 201. Moreover, the processes illustrated in S401 and S405 to S408 of the present flowchart are described in a program of a web application expanded on the RAM 212 of the client terminal 110, and are executed by the CPU 211 of the client terminal 110. In FIG. 9, the same processes as those in the feature registration process of the first embodiment are denoted by the same reference numerals. Processes different from the first embodiment are mainly explained below.

The processes of S401 to S403 are the same as those in the first embodiment. Specifically, the CPU 211 of the client terminal 110 transmits an image (second image) to the information processing apparatus 100A as the execution request of the preliminary process of the face registration. The CPU 201 of the information processing apparatus 100A receives the second image transmitted from the client terminal 110, and detects face regions of persons. Next, the process proceeds to S901.

In S901, the CPU 201 of the information processing apparatus 100A calculates the hash value of the second image received in S402. In S902, the CPU 201 of the information processing apparatus 100A stores the hash value calculated in S901 and one or multiple face regions (second face regions) detected in S403 in the temporary storage unit 802, in association with each other.

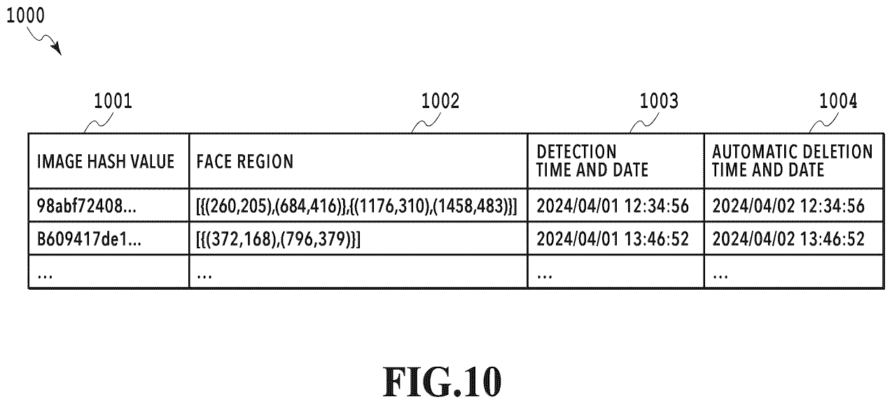

FIG. 10 is a diagram illustrating an example of a hash value table 1000 stored in the temporary storage unit 802. As illustrated in FIG. 10, records including an image hash value column 1001, a face region column 1002, a detection time and date column 1003, and an automatic deletion time and date column 1004 are stored in the hash value table 1000. Note that, in one record, an image being a target is the one same image. The hash value calculated from the image is stored in the image hash value column 1001. A list of one or multiple face regions detected from the target image is stored in the face region column 1002. The time and date of execution of the detection of the face regions for the target image is stored in the detection time and date column 1003. The time and date of automatic deletion of the record is stored in the automatic deletion time and date column 1004. Note that the information stored in the hash value table 1000 is an example, and is not limited to that described above.

In the first record of FIG. 10, the image hash value “98abf72408 . . . ” is stored in association with regions [{(260, 205), (684, 416)}, {(1176, 310), (1458, 483)}] detected from the image. Two regions of a coordinate range indicated by {(260, 205), (684, 416)} and a coordinate range indicated by {(1176, 310), (1458, 483)} are detected as the regions.

Then, in S404, the CPU 201 of the information processing apparatus 100A sends the face regions detected in S403 to the client terminal 110 as a reply.

The client terminal 110 executes the processes of S405 to S408 as in the first embodiment. Specifically, the CPU 211 of the client terminal 110 displays the face regions received as the reply, on the display device 216 of the client terminal 110. The CPU 211 designates a specific face region, and obtains the consent to the registration of the feature information for this face region, from the user.

The CPU 211 of the client terminal 110 transmits the first image and the designation information of the region for which the consent is obtained from the user, to the information processing apparatus 100A as the execution request of the face registration. The first image transmitted in this case is assumed to be an image identical to the second image transmitted in S401. Note that the first image and the second image do not have to be completely identical.

In S409, the CPU 201 of the information processing apparatus 100A receives the first image and the designation information of the region of the face for which the consent is obtained, as the execution request of the face registration. Next, the process proceeds to S903.

In S903, the CPU 201 of the information processing apparatus 100A calculates the hash value of the first image received in S409 by using the same algorithm as that in S901.

In S904, the CPU 201 makes a query about the information on the face regions stored in the temporary storage unit 802 by using the hash value calculated in S903. Specifically, the CPU 201 reads, based on the hash value calculated in S903, the information on the face regions stored in association with this hash value, from the hash value table 1000.

In S905, the CPU 201 determines whether the face regions for which the query is made in S904 include a region matching the region relating to the designation received in S409. In the determination process, the CPU 201 calculates the overlapping degree between the region relating to the designation received in S409 and each of the one or multiple face regions for which the query is made in S904. The CPU 201 determines whether the region matches or not based on the value of the overlapping degree. Specifically, the CPU 201 determines that the first face region whose value of overlapping degree is the largest and is larger than a predetermined threshold is the region “matching” the region relating to the designation. The first face region whose value of the overlapping degree is not the largest or is not larger than the predetermined threshold is determined to be a region “not matching” the region relating to the designation. Moreover, in the case where there are multiple first face regions whose overlapping degrees are the largest, the first face region whose likelihood is the largest is preferentially assumed to be the “matching” region. The overlapping degree and the likelihood are the same as those defined in the first embodiment.

In the case where the CPU 211 determines that the second face regions for which the query is made do not include the region matching the region relating to the designation in S905, the present flowchart is terminated, and the feature registration process is terminated. Meanwhile, in the case where CPU 211 determines that the second face regions for which the query is made include the region matching the region relating to the designation in S905, the process proceeds to S412.

In S412, the CPU 201 extracts the feature amount of the face while setting the region (specific region) matching the region relating to the designation as the target.

In S413, the CPU 201 stores the feature amount of the face extracted in S412 in the storage device 205 as the feature information. The extraction method of the feature amount of the face in S412 and the method of storing the feature information in S413 are the same as those in the first embodiment. Then, the present flowchart is terminated.

As explained above, the information processing apparatus 100A of the second embodiment can set any image as the target and register the feature information for a specific person captured in the image while performing the detection of face regions once. Moreover, even in the case where multiple faces are included in the image, the feature information of the face can be registered for a specific face for which the user has given the consent.

Note that, although the example in which SHA-256 algorithm is used for the calculation of the hash values of the images is explained in the second embodiment, the present disclosure is not limited to this. For example, other hashing algorithms such as SHA-512, MD5, perceptual hash, and average hash may be used to implement the calculation.

### Third Embodiment

In the first embodiment, explanation is given of an example in which the detection of the person regions is executed twice in the series of processes from the preliminary process to the registration process. Moreover, in the second embodiment, description is given of an example in which the image handled in the preliminary process and the image handled in the registration process are both hashed by using the same algorithm, and the query is made about the person regions detected in the preliminary process by using the hash value to implement the registration of the feature information with the number of times of detection of the person regions suppressed to one. Next, another example of the processing procedure in which the number of times of detection of the person regions is one is explained as a third embodiment. Note that, as in the first embodiment, an information processing apparatus 100B of the third embodiment presents the faces of the persons that are the registration targets to the user to obtain the consent individually for each person, and then registers the feature information of the person into the face recognition service. Note that, since a system configuration and a hardware configuration of the information processing system in the third embodiment are similar to those in the first embodiment, explanation thereof is omitted, and the third embodiment is explained with the same units denoted by the same reference numerals. Moreover, points different from the first embodiment are mainly explained.

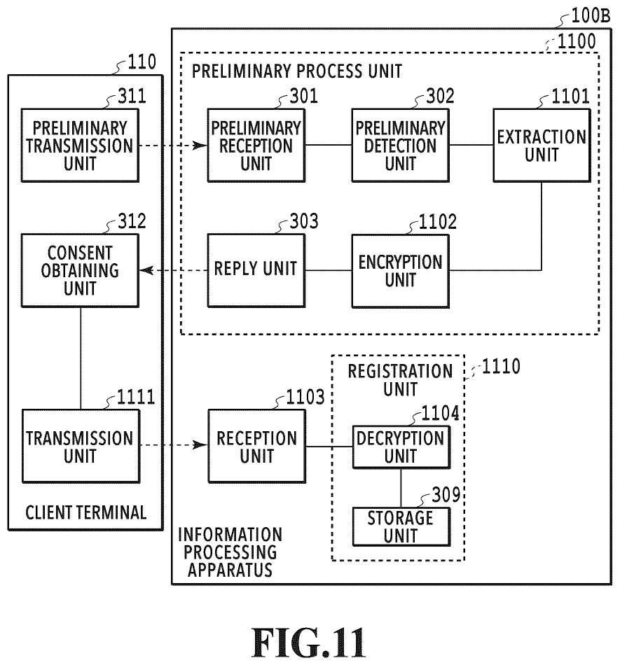

A functional configuration of the information processing apparatus 100B according to the third embodiment is explained. FIG. 11 is a block diagram illustrating the functional configuration of the information processing apparatus 100B according to the third embodiment. Note that units in FIG. 11 that are the same as the units in the functional configuration of the first embodiment are denoted by the same reference numerals as those in the first embodiment. The CPU implements functions of the functional units described below by invoking a program stored in the ROM or the storage device and executing processes according to the program.

The information processing apparatus 100B of the third embodiment includes a preliminary process unit 1100, a reception unit 1103, and a registration unit 1110. The client terminal 110 includes the preliminary transmission unit 311, the consent obtaining unit 312, and a transmission unit 1111.

The preliminary process unit 1100 includes the preliminary reception unit 301, the preliminary detection unit 302, an extraction unit 1101, an encryption unit 1102, and the reply unit 303. The registration unit 1110 includes a decryption unit 1104 and the storage unit 309.

The preliminary process unit 1100 includes the extraction unit 1101 and the encryption unit 1102 unlike in the first embodiment. Specifically, in the third embodiment, the feature information is extracted in the preliminary process. The extraction unit 1101 extracts the feature amount of the face for each of one or multiple face regions (second face regions) detected by the preliminary detection unit 302, from the image (second image) received by the preliminary reception unit 301. The encryption unit 1102 encrypts the feature amounts of the faces extracted by the extraction unit 1101.

The reply unit 303 sends one or multiple second face regions detected by the preliminary detection unit 302 and the feature amounts of the faces corresponding to the second face regions and encrypted by the encryption unit 1102, to the client terminal 110 as a reply.

The client terminal 110 receives information on the second face regions and the encrypted feature amounts of the respective face regions, from the information processing apparatus 100B. The preliminary transmission unit 311 and the consent obtaining unit 312 of the client terminal 110 are the same as those in the first embodiment. In the third embodiment, the transmission unit 1111 transmits an encrypted feature amount of a face to the information processing apparatus 100B as the execution request of the face registration. Note that the transmission unit 1111 transmits the feature amount encrypted and associated with the face region for which the consent is obtained from the user, to the information processing apparatus 100B.

The reception unit 1103 of the information processing apparatus 100B receives the encrypted feature amount of the face, from the client terminal 110 as the execution request of the face registration. The decryption unit 1104 decrypts the encrypted feature amount of the face received by the reception unit 1103. The storage unit 309 stores the feature amount of the face decrypted by the decryption unit 1104, in the storage device 205.

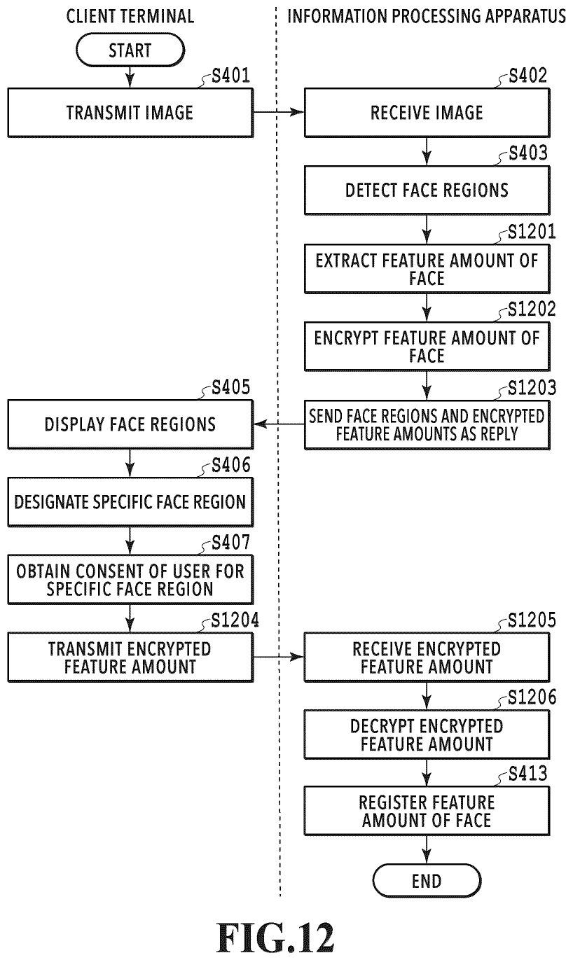

Next, the feature registration process executed by the information processing system 1B in the third embodiment is explained. FIG. 12 is a flowchart illustrating a flow of the feature registration process in the third embodiment. Processes illustrated in S402, S403, S1201 to 1203, S1205 to 1206, and S413 of the present flowchart are described in a program of a web application stored in the ROM 203 or the storage device 205 of the information processing apparatus 100B. The program is invoked by the CPU 201, expanded on the RAM 202, and executed by the CPU 201. Moreover, processes illustrated in S401, S405 to S407, and S1204 of the present flowchart are described in a program of a web application expanded on the RAM 212 of the client terminal 110, and are executed by the CPU 211 of the client terminal 110. In FIG. 12, the same processes as those in the feature registration process of the first embodiment are denoted by the same reference numerals. Processes different from the first embodiment are mainly explained below.

The processes of S401 to S403 are the same as those in the first embodiment. Specifically, the CPU 211 of the client terminal 110 transmits an image (second image) to the information processing apparatus 100B as the execution request of the preliminary process of the face registration. The CPU 201 of the information processing apparatus 100B receives the second image transmitted from the client terminal 110, and detects face regions of persons. Next, the process proceeds to S1201.

In S1201, the CPU 201 of the information processing apparatus 100B extracts the feature amount of the face for each of the one or multiple face regions detected in S403. The extraction method of the feature amount of the face is the same as that in the first embodiment.

In S1202, the CPU 201 encrypts each of the one or multiple features amounts of the faces extracted in S1201. In the present embodiment, a method of encryption is such a method that the feature amount is encrypted by using AES-256 algorithm.

In S1203, the CPU 201 associates the regions of the faces detected in S403 and the feature amounts of the faces encrypted in S1202 with one another, and sends the regions and the feature amounts to the client terminal 110 as a reply.

The client terminal 110 executes the processes of S405 to S407 as in the first embodiment. Specifically, the CPU 211 of the client terminal 110 displays the face regions received as the reply, on the display device 216 of the client terminal 110. The CPU 211 designates the specific face region, and obtains the consent to the registration of the feature information for this face region, from the user. Next, the process proceeds to S1204.

In S1204, the CPU 211 of the client terminal 110 transmits the feature amount encrypted and associated with the face region for which the consent is obtained from the user, to the information processing apparatus 100B as the execution request of the face registration.

In S1205, the CPU 201 of the information processing apparatus 100B receives the encrypted feature amount of the face, from the client terminal 110 as the execution request of the face registration.

In S1206, the CPU 201 decrypts the encrypted feature amount of the face received in S1205. The decryption is assumed to be a decryption algorithm corresponding to the encryption algorithm and a key used in S1202.

In S413, the CPU 201 stores the feature amount of the face decrypted in S1206 in the storage device 205 as the feature information. Then, the present flowchart is terminated.

As explained above, the information processing apparatus 100B of the third embodiment can set any image as the target and register the feature information for a specific person captured in an image while performing the detection of the face regions once. Moreover, even in the case where multiple faces are included in the image, the feature information can be registered for a specific face for which the user has given the consent.

Moreover, since the information processing apparatus 100B does not have to save the image and the feature information of the face is encrypted and exchanged, it is possible to reduce data holding cost and comply with legal restraints, and the service can be implemented without leakage of information. Furthermore, in the third embodiment, the image transmission from the client terminal 110 to the information processing apparatus 100B only needs to be performed once, and the communication load can be reduced from those in the first and second embodiments.

Note that, although the example in which AES-256 algorithm is used in the encryption of the feature amounts is explained in the present embodiment, the present disclosure is not limited to this example. For example, the encryption may be implemented by using other encryption algorithms such as RSA and ECC.

Although the preferable embodiments of the present disclosure are explained above with reference to the attached drawings, the present disclosure is not limited to the above-mentioned examples. For example, although the feature registration process is executed with the information processing apparatus functioning as the server and exchanging data with the client terminal in the above-mentioned embodiments, the present disclosure is not limited to this. An information processing apparatus having a server function and a client function may execute the feature registration process of each of the embodiments described above. Moreover, although the registration of the feature information is performed with the face of the person being the target, the feature information is not limited to the feature amount of the face, and a feature amount of a part of the body other than the face or other portions may be extracted and registered. In addition, it is apparent that those skilled in the art can come up with various change examples and modified examples within the scope of the disclosed technical idea, and these examples are understood to also belong to the technical scope of the present disclosure as a matter of course.

The information processing apparatus of the present disclosure can provide a service complying with AI ethics and legal restraints in a service in which feature information of a person captured in an image is registered.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-139059, filed Aug. 20, 2024, which is hereby incorporated by reference herein in its entirety.

What is claimed is:

1. An information processing apparatus comprising:
a reception unit configured to receive a first image in which one or more persons are captured and designation of a specific region in the first image, from a user; and
a registration unit configured to perform a registration process of registering feature information of a specific person included in the specific region among the one or more persons captured in the first image, wherein
consent to registration of the feature information for the specific person is obtained from the user.

2. The information processing apparatus according to claim 1, wherein
the reception unit receives a second image corresponding to the first image before reception of the designation of the specific region,
the information processing apparatus further comprises a preliminary process unit configured to detect one or more person regions from the received second image and send the one or more person regions to the user as a reply, and
the specific region is designated from among the one or more person regions detected by the preliminary process unit.

3. The information processing apparatus according to claim 2, wherein the second image is an image identical to the first image.

4. The information processing apparatus according to claim 1, wherein the registration process includes a process of detecting one or more person regions from the first image and determining whether or not each of the detected one or more person regions matches the specific region, after reception of the first image and the designation by the reception unit.

5. The information processing apparatus according to claim 4, wherein, in a case where the person region detected from the first image matches the specific region in the registration process, the feature information of the person included in the specific region is extracted.

6. The information processing apparatus according to claim 2, wherein
the reception unit receives the second image corresponding to the first image before reception of the designation,
the preliminary process unit further stores the one or more person regions detected from the second image and a second hash value determined from the second image in a storage unit in association with each other, and
the registration process includes
a process of determining a first hash value from the first image by using an algorithm identical to an algorithm used for determination of the second hash value and obtaining the one or more person regions detected from the second image from the storage unit by using the first hash value, and
a process of determining whether or not each of the one or more detected person regions matches the specific region.

7. The information processing apparatus according to claim 6, wherein, in a case where the person region detected from the first image and the specific region match each other in the registration process, the feature information of the person included in the specific region is extracted.

8. The information processing apparatus according to claim 2, wherein
the reception unit receives the first image and the designation from a client terminal communicably connected to the information processing apparatus, and
the preliminary process unit receives the second image from the client terminal, and sends the one or more person regions detected from the second image to the client terminal as the reply.

9. The information processing apparatus according to claim 8, wherein the preliminary process unit causes the client terminal to display a screen depicting one or more persons included in the one or more person regions detected from the second image.

10. An information processing apparatus comprising:
a preliminary process unit configured to receive an image from a user and send one or more person regions included in the image and one or more pieces of feature information in association with each other as a reply, the one or more pieces of feature information extracted, respectively, from the one or more person regions and encrypted;
a reception unit configured to receive the feature information associated with a specific region including a specific person among the one or more person regions included in the reply; and
a registration unit configured to decrypt and register the feature information received by the reception unit, wherein
consent to registration of the feature information for the specific person is obtained from the user.

11. The information processing apparatus according to claim 10, wherein
the preliminary process unit receives the image from a client terminal communicably connected to the information processing apparatus, and sends the reply to the client terminal, and
the reception unit receives the feature information associated with the specific region designated in the client terminal.

12. The information processing apparatus according to claim 11, wherein the preliminary process unit causes the client terminal to display a screen depicting one or more persons included in the one or more person regions detected from the image.

13. The information processing apparatus according to claim 9, wherein the screen includes an inquiry to the user about the consent to the registration of the feature information by the registration unit for each of the one or more persons displayed on the screen.

14. The information processing apparatus according to claim 13, wherein the one or more persons being targets of the inquiry are sequentially changed and displayed on the screen.

15. The information processing apparatus according to claim 13, wherein a designation operation of the one or more persons being targets of the inquiry is received from the user on the screen.

16. The information processing apparatus according to claim 1, wherein
the specific region includes a face region, and
the feature information is a feature amount of a face.

17. An information processing apparatus capable of being communicably connected to a client terminal, the information processing apparatus comprising:
a reception unit configured to receive an image transmitted from the client terminal;
a reply unit configured to send information on one or more persons detected from the image as a reply such that the information is visually recognizable by a user of the client terminal; and
a registration unit configured to register feature information of a specific person for which consent of the user is obtained, among the one or more persons detected from the image.

18. An information processing system in which an information processing apparatus and a client terminal are communicably connected to each other via a network, wherein
the information processing apparatus includes:
a reception unit configured to receive a first image in which one or more persons are captured and designation of a specific region in the first image, from the client terminal; and
a registration unit configured to perform a registration process of registering feature information of a specific person included in the specific region among the one or more persons captured in the first image, and
the client terminal includes a transmission unit configured to transmit the first image and the designation of the specific region including the specific person in the first image to the information processing apparatus in a case where consent to registration of the feature information for the specific person is obtained from a user.

19. An information processing system in which an information processing apparatus and a client terminal are communicably connected to each other via a network, wherein
the information processing apparatus includes:
a preliminary process unit configured to receive an image from the client terminal and send one or more person regions included in the image and one or more pieces of feature information in association with each other to the client terminal as a reply, the one or more pieces of feature information extracted, respectively, from the one or more person regions and encrypted;
a reception unit configured to receive the feature information associated with a specific region including a specific person among the one or more person regions included in the reply, from the client terminal; and
a registration unit configured to decrypt and register the feature information received by the reception unit, and
the client terminal includes a transmission unit configured to transmit the feature information associated with the specific region to the information processing apparatus in a case where consent to registration of the feature information for the specific person designated from the one or more person regions included in the reply is obtained from the user.

20. An information processing system in which an information processing apparatus and a client terminal are communicably connected to each other via a network, wherein
the information processing apparatus includes:
a reception unit configured to receive an image transmitted from the client terminal;
a reply unit configured to send information on one or more persons detected from the image to the client terminal as a reply; and
a registration unit configured to register feature information of a specific person for which consent of a user is obtained, among the one or more persons detected from the image, and
the client terminal includes:
an inquiry unit configured to present the one or more persons detected from the image based on the reply such that the one or more persons are visually recognizable by the user, and inquire about the consent of the user to the registration of the feature information for each of the one or more presented persons; and
a request unit configured to request the information processing apparatus to register the feature information of the specific person for which the consent is obtained by the inquiry unit.

21. An information processing method executed by an information processing apparatus, the information processing method comprising:
receiving a first image in which one or more persons are captured and designation of a specific region in the first image, from a user; and
performing a registration process of registering feature information of a specific person included in the specific region among the one or more persons captured in the first image, wherein
consent to registration of the feature information for the specific person included in the specific region is obtained from the user.

22. An information processing method executed by an information processing apparatus, the information processing method comprising:
receiving an image from a user and sending one or more person regions included in the image and one or more pieces of feature information in association with each other as a reply, the one or more pieces of feature information extracted, respectively, from the one or more person regions and encrypted;
receiving the feature information associated with a specific region including a specific person among the one or more person regions included in the reply; and
decrypting and registering the received feature information, wherein
consent to registration of the feature information for the specific person is obtained from the user.

23. An information processing method executed by an information processing apparatus capable of being communicably connected to a client terminal, the information processing method comprising:
receiving an image transmitted from the client terminal;
sending information on one or more persons detected from the image as a reply such that the information is visually recognizable by a user of the client terminal; and
registering feature information of a specific person for which consent of the user is obtained, among the one or more persons detected from the image.

24. A non-transitory computer readable storage medium storing a program which causes a computer to execute an image processing method comprising:
receiving a first image in which one or more persons are captured and designation of a specific region in the first image, from a user; and
performing a registration process of registering feature information of a specific person included in the specific region among the one or more persons captured in the first image, wherein
consent to registration of the feature information for the specific person included in the specific region is obtained from the user.

25. A non-transitory computer readable storage medium storing a program which causes a computer to execute an information processing method comprising:
receiving an image from a user and sending one or more person regions included in the image and one or more pieces of feature information in association with each other as a reply, the one or more pieces of feature information extracted, respectively, from the one or more person regions and encrypted;
receiving the feature information associated with a specific region including a specific person among the one or more person regions included in the reply; and
decrypting and registering the received feature information, wherein
consent to registration of the feature information for the specific person is obtained from the user.

26. A non-transitory computer readable storage medium storing a program which causes a computer to execute an information processing method executed by a computer capable of being communicably connected to a client terminal, the information processing method comprising:
receiving an image transmitted from the client terminal;
sending information on one or more persons detected from the image as a reply such that the information is visually recognizable by a user of the client terminal; and
registering feature information of a specific person among the one or more persons detected from the image.
